(19) United States
(12) Patent Application Publication
(10) Pub. No.: US 2011/0134831 A1
(43) Pub. Date: Jun. 9, 2011

(54) Architecture Providing Multi-System Carrier Aggregation

(75) Inventor: Juho M.O. Pirskanen, Tampere (FI)

(73) Assignee: Nokia Corporation

(21) Appl. No.: 12/630,257

(22) Filed: Dec. 3, 2009

(51) Int. Cl. H04W 40/00

(52) U.S. Cl. 370/328

(57) ABSTRACT

Disclosed is a method for enabling interoperability between different types of wireless communication systems operating with different types of air interfaces to provide at least downlink radio resource aggregation for a user equipment. The method includes providing a common set of upper radio layer functionalities for one or more radio bearers assigned to the user equipment, the one or more radio bearers being associated with a first wireless communication system and a second wireless communication system. The method further includes performing wireless communications with the user equipment via one or more of the radio bearers via the first and second wireless communication systems.

### TECHNICAL FIELD

The exemplary and non-limiting embodiments of this invention relate generally to wireless communication systems, methods, devices and computer programs and, more specifically, relate to carrier aggregation compatibility between different wireless communication systems.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project
ACK acknowledge
BTS base transceiver system
BW bandwidth
C-Plane control plane
CN core network
CQI channel quality indicator
DC dual carrier
DL downlink (eNB, Node B towards UE)
E-DCH enhanced downlink channel
EDGE enhanced data rates for GSM evolution
eNB EUTRAN Node B (evolved Node B)
EPC evolved packet core
EUTRAN evolved UTRAN (LTE)
GGSN gateway general packet radio system support node
GSM global system for mobile communication
HARQ hybrid automatic repeat request
HO handover
HS-DSCH high speed downlink shared channel
HSPA high speed packet access
HSDPA high speed downlink packet access
HSUPA high speed uplink packet access
I-HSPA internet HSPA (evolved HSPA)
IP internet protocol
L1 layer 1 (physical (Phy) layer)
L2 layer 2 (MAC layer)
LTE long term evolution
MAC medium access control
MM/MME mobility management/mobility management entity
NACK not acknowledge/negative acknowledge
NBAP Node B application part (signaling)
Node B base station (includes BTS)
OFDMA orthogonal frequency division multiple access
O&M operations and maintenance
PDCP packet data convergence protocol
PDU protocol data unit
Phy physical
RACH random access channel
RAT radio access technology
RB radio bearer
RLC radio link control
RNC radio network controller
ROHC robust (internet) header compression
RRC radio resource control
SGSN serving gateway support node
SGW serving gateway
SC-FDMA single carrier, frequency division multiple access
TCP transmission control protocol
TFRC TCP-friendly rate control
TTI transmit time interval
U-Plane user plane
UE user equipment
UL uplink (UE towards eNB, Node B)
UTRAN universal terrestrial radio access network WCDMA wideband code division multiple access

The specification of a communication system known as evolved UTRAN (EUTRAN, also referred to as UTRAN-LTE or as EUTRA) has been specified by 3GPP in Rel-8. As specified the DL access technique is OFDMA, and the UL access technique is SC-FDMA.

One specification of interest is 3GPP TS 36.300, V8.10.0 (2009-9), 3rd Generation Partnership Project; Technical Specification Group Radio Access Network; Evolved Universal Terrestrial Radio Access (EUTRA) and Evolved Universal Terrestrial Access Network (EUTRAN); Overall description; Stage 2 (Release 8). This system may be referred to for convenience as LTE Rel-8 (with also contains 3G HSPA and its improvements). In general, the set of specifications given generally as 3GPP TS 36.xyz (e.g., 36.211, 36.311, 36.312, etc.) may be seen as describing the Release 8 LTE system. More recently, Release 9 versions of at least some of these specifications have been published including 3GPP TS 36.300, V9.1.0 (2009-9).

FIG. 1A reproduces Figure. 4.1 of 3GPP TS 36.300, and shows the overall architecture of the E-UTRAN system. The E-UTRAN system includes eNBs, providing the EUTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME (Mobility Management Entity) by means of a S1 MME interface and to a Serving Gateway (SGW) by means of a S1 interface. The S1 interface supports a many to many relationship between MMEs/Serving Gateways and eNBs.

The eNB hosts the following functions:

functions for Radio Resource Management: Radio Bearer Control, Radio Admission Control, Connection Mobility Control, Dynamic allocation of resources to UEs in both uplink and downlink (scheduling);
IP header compression and encryption of the user data stream;
selection of a MME at UE attachment;
routing of User Plane data towards Serving Gateway;
scheduling and transmission of paging messages (originated from the MME);
scheduling and transmission of broadcast information (originated from the MME or O&M); and
measurement and measurement reporting configurations to provide mobility and scheduling.

Of particular interest herein are the further releases of 3GPP LTE targeted towards future IMT-A systems, referred to herein for convenience simply as LTE-Advanced (LTE-A).

Reference can be made to 3GPP TR 36.814, V1.3.1 (2009-06), 3rd Generation Partnership Project; Technical Specification Group Radio Access Network; Further Advancements for E-UTRA Physical Layer Aspects (Release 9). Reference can also be made to 3GPP TR 36.913, V8.0.1 (2009-03), 3rd Generation Partnership Project; Technical Specification Group Radio Access Network; Requirements for Further Advancements for E-UTRA (LTE-Advanced) (Release 8). A goal of LTE-A is to provide significantly enhanced services by means of higher data rates and lower latency with reduced cost.

As is specified in 3GPP TR 36.913, LTE-A should operate in spectrum allocations of different sizes, including wider spectrum allocations than those of Rel-8 LTE, e.g., up to 100 MHz, to achieve the peak data rate of 100 Mbit/s for high mobility and 1 Gbit/s for low mobility. It has been agreed that carrier aggregation is considered for LTE-A in order to support bandwidths larger than 20 MHz. Carrier aggregation, where two or more component carriers (CCs) are aggregated, is considered for LTE-Advanced in order to support transmission bandwidths larger than 20 MHz. The carrier aggregation could be contiguous or non-contiguous.

A terminal may simultaneously receive one or multiple component carriers depending on its capabilities. An LTE-Advanced terminal with reception capability beyond 20 MHz can simultaneously receive transmissions on multiple component carriers. An LTE Rel-8 terminal can receive transmissions on a single component carrier only, provided that the structure of the component carrier follows the Rel-8 specifications.

FIG. 1B shows an example of the carrier aggregation, where M Rel-8 component carriers are combined together to form M×Rel-8 BW, e.g. 5×20 MHz=100 MHz given M=5. Rel-8 terminals receive/transmit on one component carrier, whereas LTE-Advanced terminals may receive/transmit on multiple component carriers simultaneously to achieve higher (wider) bandwidths.

Moreover, it is required that LTE-A should be backwards compatible with Rel-8 LTE in the sense that a Rel-8 LTE terminal should be operable in the LTE-A system, and that a LTE-A terminal should be operable in a Rel-8 LTE system.

Typically all wireless systems operate on a single carrier even though multi-carrier technologies have been recently introduced. Here the multi-carrier is understood as being a center frequency of the TX band, and not an OFDM system per se.

This was the general situation in GSM, WCDMA and LTE (Rel-8) in their first releases, all of which utilize single carrier transmission. However, subsequently multi-carrier operation has been introduced in GERAN EDGE and WCDMA HSDPA (3GPP TS 25.308, V8.7.0 (2009-09) Rel-8) and HSUPA (3GPP TS 25.319 V9.1.0 (2009-09) Rel-9) operation. The Rel-8 definition for HSDPA contains support for multicarrier operation inside the same frequency band, and in Rel-9 3GPP TS 25.308, V9.1.0 the support was extended to cover multicarrier operation between different frequency bands.

FIG. 1C shows a simplified block diagram of the HSPA system. A RNC in combination with a plurality of Node Bs (connected via an Iub interface) forms the UTRAN, while a CN, that includes a SGSN and a GGSN, provides connectivity with external networks (e.g., the Internet). The UTRAN and CN are connected via an Iu interface.

In HSPA (i.e., HSDPA and HSUPA) multi-carrier operation the UE and Node B transmit on two parallel carriers in an independent manner. The multi-carrier operation can be seen as multiple, parallel single-carrier transmissions on different carrier frequencies to and from the single UE.

In the LTE-A resource aggregation (carrier aggregation) the situation is currently that the basic principles are similar, as each component carrier (single Rel-8 carrier) operates independently of the other component carriers.

However, yet to be considered are various aspects of carrier aggregation and/or multi-carrier operation between different radio technologies.

### SUMMARY

The foregoing and other problems are overcome, and other advantages are realized, by the use of the exemplary embodiments of this invention.

In a first aspect thereof the exemplary embodiments of this invention provide a method to enable interoperability between different types of wireless communication systems operating with different types of air interfaces to provide at least downlink radio resource aggregation for a user equipment. The method includes providing a common set of upper radio layer functionalities for one or more radio bearers assigned to the user equipment, the one or more radio bearers being associated with a first wireless communication system and a second wireless communication system. The method further includes performing wireless communications with the user equipment via one or more of the radio bearers via the first and second wireless communication systems.

In a second aspect thereof the exemplary embodiments of this invention provide an apparatus that comprises a processor and a memory including computer program code. The memory and computer program code are configured to, with the processor, cause the apparatus at least to perform enabling interoperability between different types of wireless communication systems operating with different types of air interfaces to provide at least downlink radio resource aggregation for a user equipment by providing a common set of upper radio layer functionalities for one or more radio bearers assigned to the user equipment. The one or more radio bearers are associated with different types of wireless communication systems. The apparatus further performs wireless communications with the user equipment with one or more radio bearers via the different types of wireless communication systems.

In a further aspect thereof the exemplary embodiments of this invention provide a method that comprises performing transmission and reception between radio access networks operating with wireless communication systems having different types of air interfaces to enable at least downlink radio resource aggregation for one or more radio bearers by having a common set of upper radio layer functionalities for one or more assigned radio bearers; and performing wireless communications with the radio access networks with the one or more radio bearers via the wireless communication systems having different air interfaces.

In another aspect thereof the exemplary embodiments of this invention provide an apparatus that comprises a processor and a memory including computer program code. The memory and computer program code are configured to, with the processor, cause the apparatus at least to perform transmitting and receiving with radio access networks operating with wireless communication systems having different types of air interfaces to enable at least downlink radio resource aggregation for one or more radio bearers by having a common set of upper radio layer functionalities for one or more assigned radio bearers; and performing wireless communications with the radio access networks with the one or more radio bearers via the wireless communication systems having different air interfaces.

### BRIEF DESCRIPTION OF THE DRAWINGS

In the attached Drawing Figures:

FIG. 1A reproduces Figure. 4.1 of 3GPP TS 36.300, and shows the overall architecture of the EUTRAN system.

FIG. 1B shows an example of carrier aggregation as proposed for the LTE-A system.

FIG. 1C shows a simplified block diagram of the HSPA system.

FIG. 2 shows a simplified block diagram of various electronic devices that are suitable for use in practicing the exemplary embodiments of this invention.

FIG. 3 shows one non-limiting example of frequency allocation, and is useful in explaining a problem that is overcome by the use of the exemplary embodiments of this invention.

FIG. 4 shows one exemplary embodiment of protocol stacks for a DL case of the U-Plane, with the RRC connection located at the E-UTRAN eNB.

FIG. 5 shows one exemplary embodiment of protocol stacks for a DL case of the C-Plane, with the RRC connection located at the E-UTRAN eNB.

FIG. 6 shows one exemplary embodiment of protocol stacks for an UL case of the U-Plane, with the RRC connection located at the E-UTRAN eNB.

FIG. 7 illustrates an embodiment of signaling flow to initiate resource aggregation, assuming use of the RRC in E-UTRAN, in accordance with the embodiments depicted in FIGS. 4, 5 and 6.

FIG. 8 shows another exemplary embodiment of protocol stacks for a DL case of the U/C-Plane, with the RRC connection located at the UTRAN Node B.

FIG. 9 shows another exemplary embodiment of protocol stacks for an UL case of the U/C-Plane, with the RRC connection located at the UTRAN RNC.

FIG. 10 illustrates an embodiment of signaling flow to initiate resource aggregation, assuming use of the RRC in UTRAN, in accordance with the embodiments depicted in FIGS. 8 and 9.

FIG. 11A is a simplified diagram of a DL architecture.

FIG. 11B is another view of the DL architecture, one that shows the position of a data routing switch (a logical switch) between the output of RLC buffers and inputs of the LTE and UTRAN MAC layers.

FIGS. 12 and 13 are each a logic flow diagram that illustrates the operation of a method, and a result of execution of computer program instructions embodied on a computer readable memory, in accordance with the exemplary embodiments of this invention.

### DETAILED DESCRIPTION

Frequency allocation for certain radio technologies such as HSPA or LTE is a long lasting and important decision that fixes that frequency or band(s) of frequencies to that technology for some extended period of time. In general, the re-allocation of currently allocated and in-use frequencies is not straightforward, as existing installations are used for as long as possible (most likely preference from operators). An existing subscriber base using legacy devices expect to have the legacy frequencies available, and many system operators may not have a sufficient number of available frequencies to support these legacy subscribers if some significant amount of frequency resources are transferred from the legacy system to a new system (e.g., from GSM to HSPA or LTE, or from HSPA to LTE or LTE-A). Further, a new technology typically has fewer initial subscribers than a pre-existing legacy technology and, as a result, allocating significant frequency resources to the new technology will result in poor frequency utilization (at least initially).

As the current HSPA and LTE resource aggregation or multi-carrier schemes do not support aggregation between these two wideband radio technologies, an operator offering to provide wide bandwidth to a single UE is limited in available radio access technology.

Furthermore as only inter-RAT HOs are supported between UTRAN and E-UTRAN the resource and load sharing cannot be made dynamic. Further, there is little or no possibility to develop systems were gains resulting from frequency-selective scheduling when using different radio access technologies. This is due at least to fast changing radio conditions requiring a rapid scheduling decision of the selected frequency components, which cannot be accommodated by different inter-RAT HO schemes.

As the number of HSPA subscribers and networks are increasing rapidly, and the introduction of commercial LTE networks and terminals is still at an early stage, it can be expected that there will exist a significant HSPA legacy base when LTE systems become more widely deployed. It can be appreciated then that it would be beneficial to develop a basic protocol architecture capable of supporting carrier aggregation between, for example, LTE and HSPA.

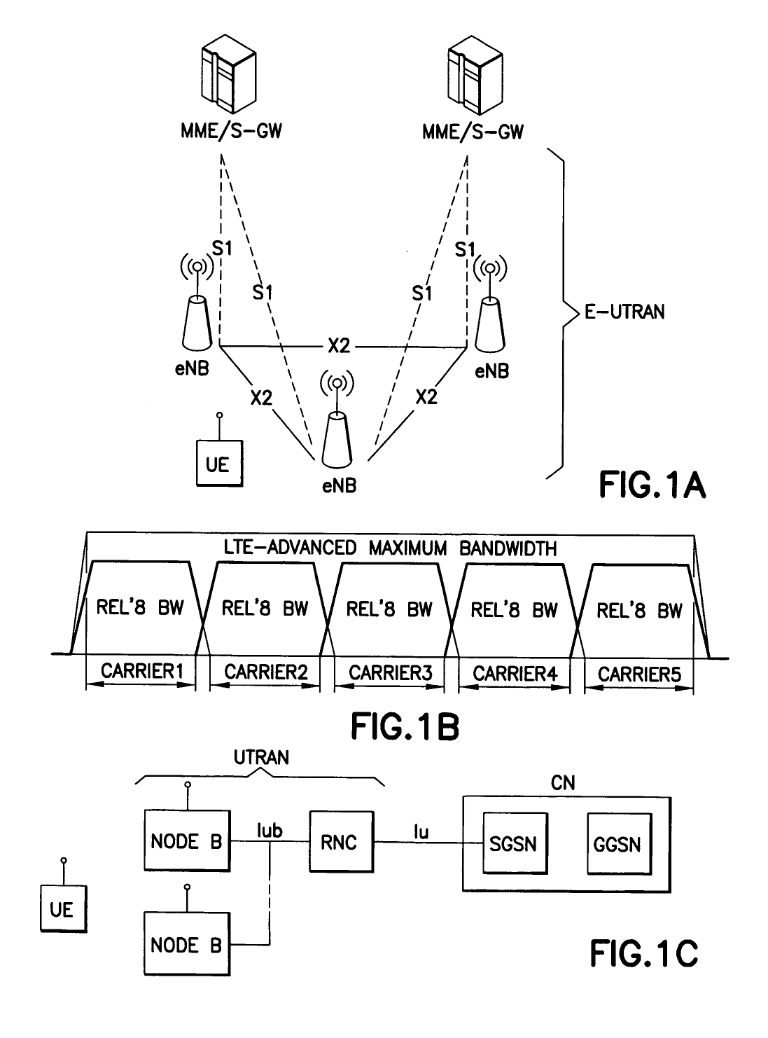

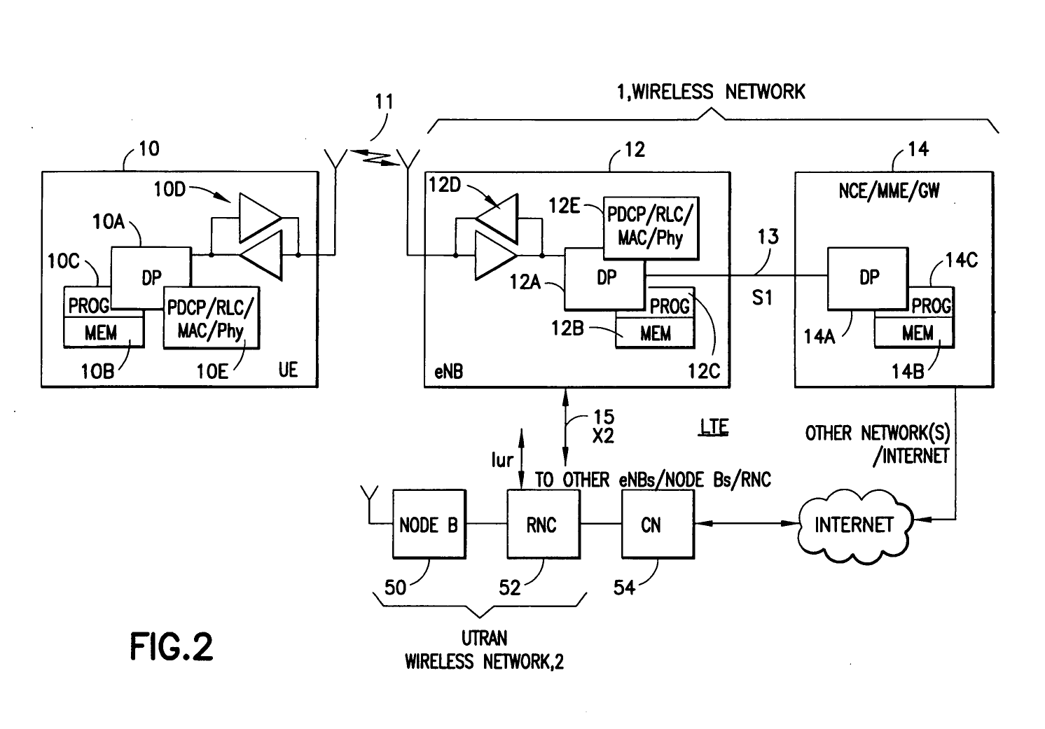

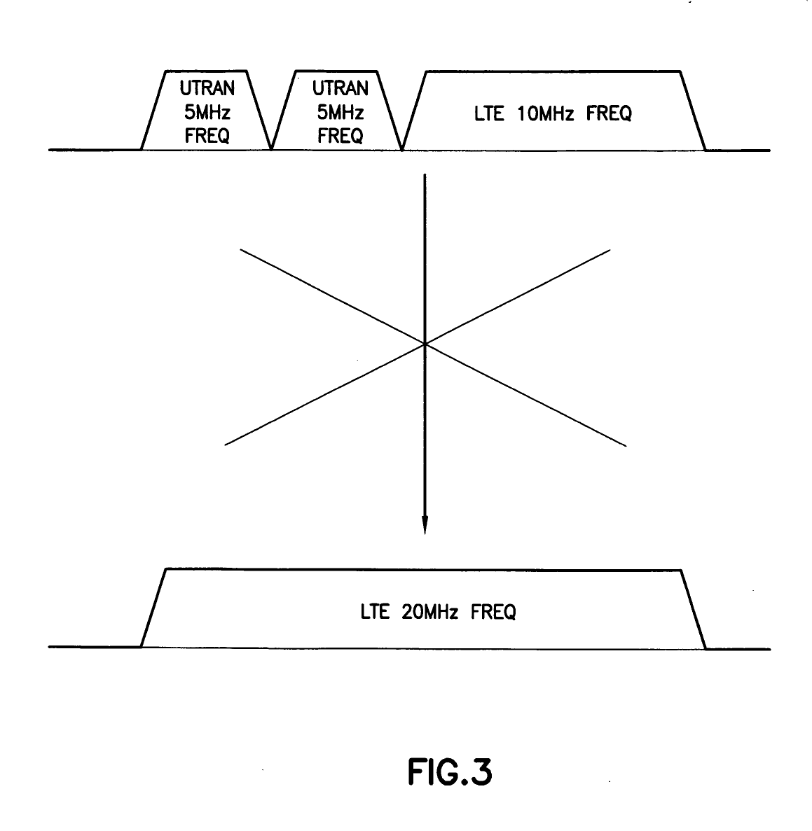

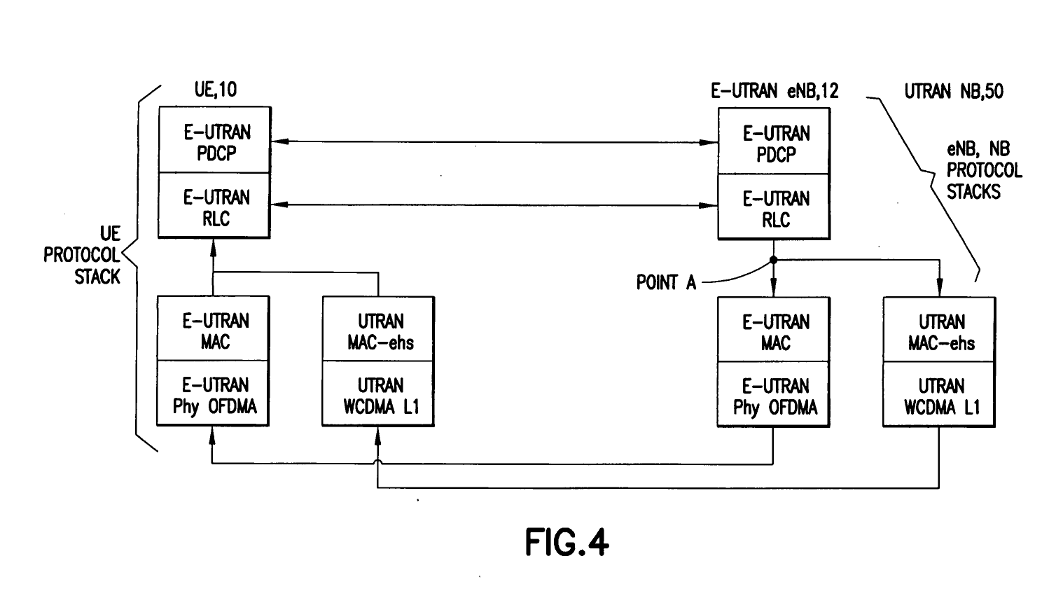

Before describing in further detail the exemplary embodiments of this invention, reference is made to FIG. 2 for illustrating a simplified block diagram of various electronic devices and apparatus that are suitable for use in practicing the exemplary embodiments of this invention. In FIG. 2 a wireless network 1 is adapted for communication over a wireless link 11 with an apparatus, such as a mobile communication device which may be referred to as a UE 10, via a network access node, such as an eNB 12 for the case of an LTE or LTE-A network. The network 1 may include a network control element (NCE) 14 that may include the MME/SGW functionality shown in FIG. 1A, and which provides connectivity with a further network, such as a telephone network and/or a data communications network (e.g., the internet). The UE 10 includes a controller, such as a computer or a data processor (DP) 10A, a computer-readable memory medium embodied as a memory (MEM) 10B that stores a program of computer instructions (PROG) 10C, and at least one suitable radio frequency (RF) transceiver 10D for bidirectional wireless communications with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and at least one suitable RF transceiver 12D for communication with the UE 10 via one or more antennas. The eNB 12 is coupled via a data/control path 13 to the NCE 14. The path 13 may be implemented as the S1 interface shown in FIG. 1A. The eNB 12 may also be coupled to another eNB via data/control path 15, which may be implemented as the X2 interface shown in FIG. 1A.

For the purposes of describing the exemplary embodiments of this invention the UE 10 may be assumed to also include a protocol stack (e.g., at least PDCP, RLC/MAC/Phy)10E, and the eNB 12 includes a protocol stack (e.g., at least PDCP, RLC/MAC/Phy) 12E.

Also shown in FIG. 2 is a second wireless network 2, such as a HSPA wireless network including at least one Node B 50, at least one RNC 52 (together foaming the UTRAN) and a CN 54 providing connectivity with a further network, such as a telephone network and/or a data communications network (e.g., the internet). It is assumed that the Node B 50, the RNC 52 and the elements of the CN 54 (e.g., the SGSN and GGSN) will be similarly constructed to also include data processors, memories storing computer programs and other data, and the necessary wireless transceivers and the like for communication with the UE 10.

It is assumed for the purposes of this invention that the UE 10 is a multi-mode (dual mode or higher) device capable of operation in different types of wireless networks. For example, there can be a plurality of transceivers 10D, where one or more operate in accordance with LTE OFDMA, and where one or more other transceivers operate in accordance with HSPA WCDMA. The program stored in memory 10B is thus assumed to be capable of operation with two or more different types of wireless networks as well, and for establishing and operating the protocol stack 10E in accordance with the particular type of wireless network standard that is in effect at any given time. The protocol stack 10E, as well as the protocol stack 12E, may be considered as being implemented solely as computer program code, or as a combination of computer program code and various hardware elements, including memory locations, data processors, buffers, interfaces and the like.

At least one of the PROGs of the eNB 12 and/or the Node B50 and/or the RNC 52 is assumed to include program instructions that, when executed by the associated DP, enable the device to operate in accordance with the exemplary embodiments of this invention, as will be discussed below in greater detail. That is, the exemplary embodiments of this invention may be implemented at least in part by computer software executable by data processors, or by hardware, or by a combination of software and hardware (and firmware).

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multi-core processor architecture, as non-limiting examples.

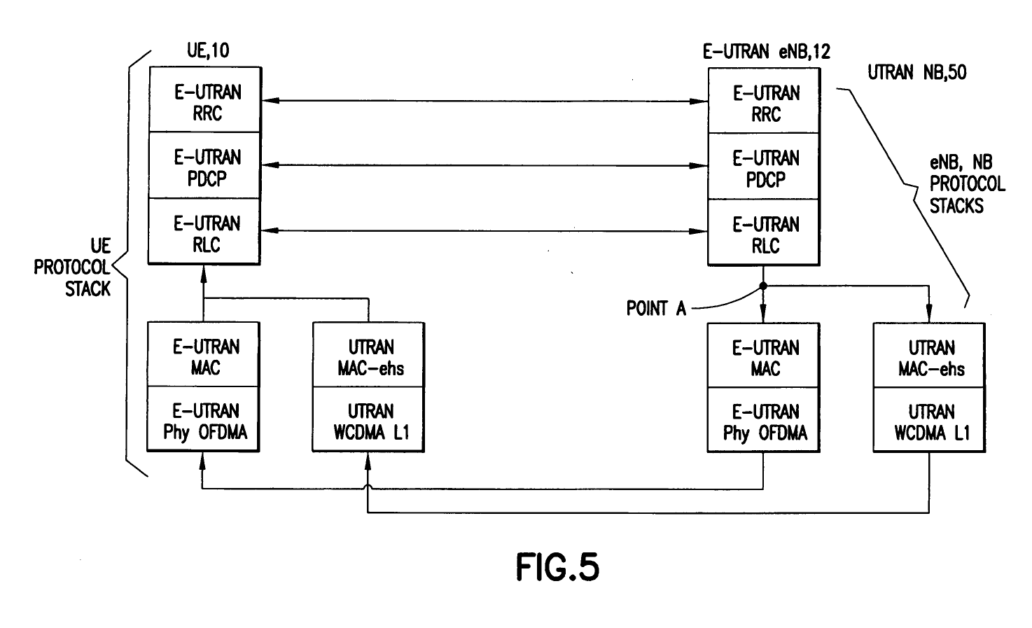

As was noted above, the use of resource aggregation is becoming more attractive in both LTE and HSPA (i.e., dual/multi-carrier/band operation in HSPA and the utilization of multiple component carriers in LTE). Those frequencies allocated to HSPA or LTE are fixed to that technology for some certain time, and the re-allocation of the frequencies is not straightforward. Reference can be made to FIG. 3, which shows one non-limiting example of frequency allocation. In this example the operator has 20 MHz within a certain band. The initial allocation is, for example, 2×5 MHz for UTRAN and 10 MHz for E-UTRAN. However, re-allocating all 10 MHz of UTRAN bandwidth to LTE is not feasible due to the adverse impact on the legacy UTRAN user terminals. In this case the maximum bandwidth that the operator can provide to a single UE is 10 MHz, either with LTE Rel-8 or HSPA DC operation.

In this case resource and load sharing between LTE and UTRAN is only possible with HO and reselection rules. Frequency-selective scheduling is not possible between these two technologies.

The problems that arise and that are addressed by the exemplary embodiments of this invention include, but need not be limited to, the following.

A) How can the operator best utilize its frequency assets more flexibly and in a backward compatible manner?
B) How to best avoid problematic re-farming (re-allocation) scenarios from UTRAN to LTE?
C) How to provide a wider bandwidth to the UEs even when re-allocation of the bandwidth is not desired or possible (not being limited by radio access technology)?
D) How to provide fast load sharing and frequency-dependent scheduling gains between LTE and UTRAN?

With regards then to carrier aggregation between UTRAN and LTE it is desirable to provide flexible frequency utilization, backwards compatibility for both LTE/HSPA, a larger available bandwidth without technology limitation, a BTS implementation supporting both LTE/HSPA, and the possibility to provide a single chip implementation to support both modes of operation.

Several goals can include an improved migration bath from HSPA to LTE, 3GPP technologies able to provide larger bandwidth, both the UL and DL L1 may be maintained without change, and the utilization by HSPA of the LTE layer 2 (RLC, PDCP layers) and security functions.

In accordance with the exemplary embodiments of this invention the foregoing problems are overcome and the goals are realized in accordance with several basic principles. These basic principles include at least the following.

A) The feature is preferably not visible to the CN (or only very minor additions needed to support control plane signaling if no interface exists between the eNB and the RNC).
B) The RRC connection is terminated in either E-UTRAN or UTRAN (eNB or RNC). The preference may be to terminate the RRC in E-UTRAN as this architecture would enable the use of the E-UTRAN RLC and PDCP layers. Ciphering on the PDCP would facilitate improved UL L2 processing in the UE 10 as ciphering is decoupled from RLC segmentation, and from the actual uplink data transmission based on the scheduled grant given by the network. One or both options may be supported by a standard.
C) The RRC, PDCP and RLC are located either in the eNB 12 or in the RNC (I-HSPA in NodeB), i.e., at the same location where the RRC connection is terminated. The RRC, PDCP and RLC operate based on E-UTRAN when terminated in the eNB 12, or as in UTRAN if terminated in the RNC 52. Security (ciphering and integrity protection) is terminated in the same location based on the terminating technology, i.e., either on the PDCP (LTE) or in the RLC (UTRAN). As the RRC is terminated in a single location the mobility management, radio resource management, connection configuration, handling of UE capabilities, and other RRC functions defined for controlling the UE 10 are handled in a centralized manner for both radio access technologies. As a single RLC protocol layer supports both radio access technologies (e.g., E-UTRAN, UTRAN) the RLC can support re-transmissions for complete data flow transmitted via either one or both radio technologies, the RLC can provide in-sequence delivery towards upper layers even though the two radio access technologies may have different RTTs (round trip times).
D) The E-UTRAN MAC operates on top of the LTE L1, routing data to/from the RLC.
E) The MAC-ehs operates between the WCDMA L1 and the RLC for HSPA DL operation, and the MAC-i/is located between the WCDMA L1 and the RLC in the UL.
F) The use of these exemplary embodiments further provides for maximum re-use of existing protocol layers and functions from both radio access technologies. Note that while it may be possible to define single MAC layer or radio protocol architecture that could support the required functions for both E-UTRAN and HSPA, such an approach would require a completely new design or re-design of the MAC or the complete protocol architecture, respectively. As such, problems would arise at least with respect to the already installed base of legacy UEs 10 and network components.

More particularly, above the physical layer (L1) in a 3GPP system the MAC layer may be divided into several entities. One MAC entity, MAC enhanced high speed (MAC-ehs), has been introduced and optimized for HSPA in the DL. The MAC-ehs entity can be used alternatively to a MAC high speed (MAC-hs). In the UL a MAC entity, improved MAC (MAC-i/is), has been introduced and optimized for HSPA. The MAC-i/is entity can be used alternatively to a MAC-e/es. The MAC-ehs and/or MAC-i/is entity is configured by higher layers which handle the data transmitted on the HS-DSCH and/or on the E-DCH, and manage the physical resources allocated to HS-DSCH. The MAC-ehs entity permits the support of flexible RLC PDU sizes as well as MAC segmentation and reassembly. Unlike MAC-hs for HSDPA, MAC-ehs allows the multiplexing of data from several priority queues within one TTI (e.g., 2 ms).

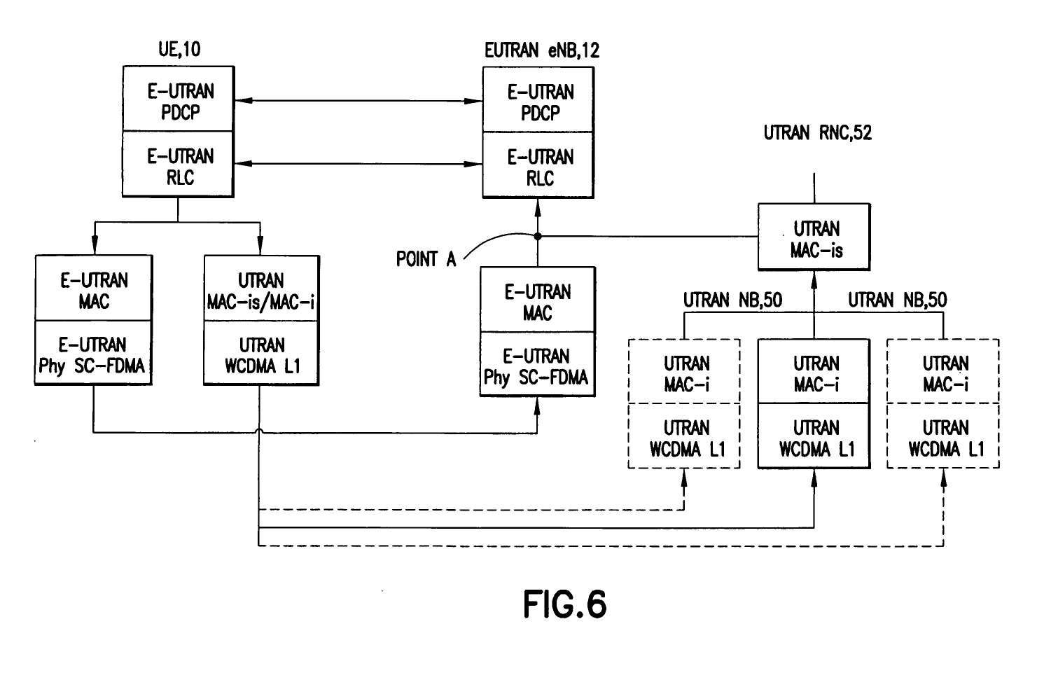

G) Both the LTE and WCDMA layer 1 operate independently and simultaneously. If only DL carrier aggregation is supported the UL that is used is modified to support the other technology, implying changes being made to HARQ, ACK/NACK and CQI reporting.
H) In a basic case the UTRAN Node B and the eNB 12 can be co-located. If these units are located in different physical entities then so-called simple CoMP (coordinated multipoint transmission) can be enabled between LTE and UTRAN.
FIG. 4 shows one exemplary embodiment of protocol stacks for a DL case of the U-Plane, with the RRC connection located at the E-UTRAN eNB 12 (designated as Point A). The Point A may be a physical connection point and/or a logical connection point between the E-UTRAN eNB 12 RLC and MAC layers. As the UTRAN MAC-ehs supports segmentation, re-ordering and the inclusion of multiple RLC PDUs into a single MAC-ehs PDU, the RLC layer above the MAC layer would need few if any modifications. Also shown in FIG. 4 is the UTRAN Node-B (NB 50, see FIG. 2). Note that L1 for E-UTRAN (physical (Phy) layer) is shown as OFDMA, while the UTRAN L1 is WCDMA. The UE 10 is thus assumed to be a multi-mode device, capable of operation with either the OFDMA or WCDMA physical layers.

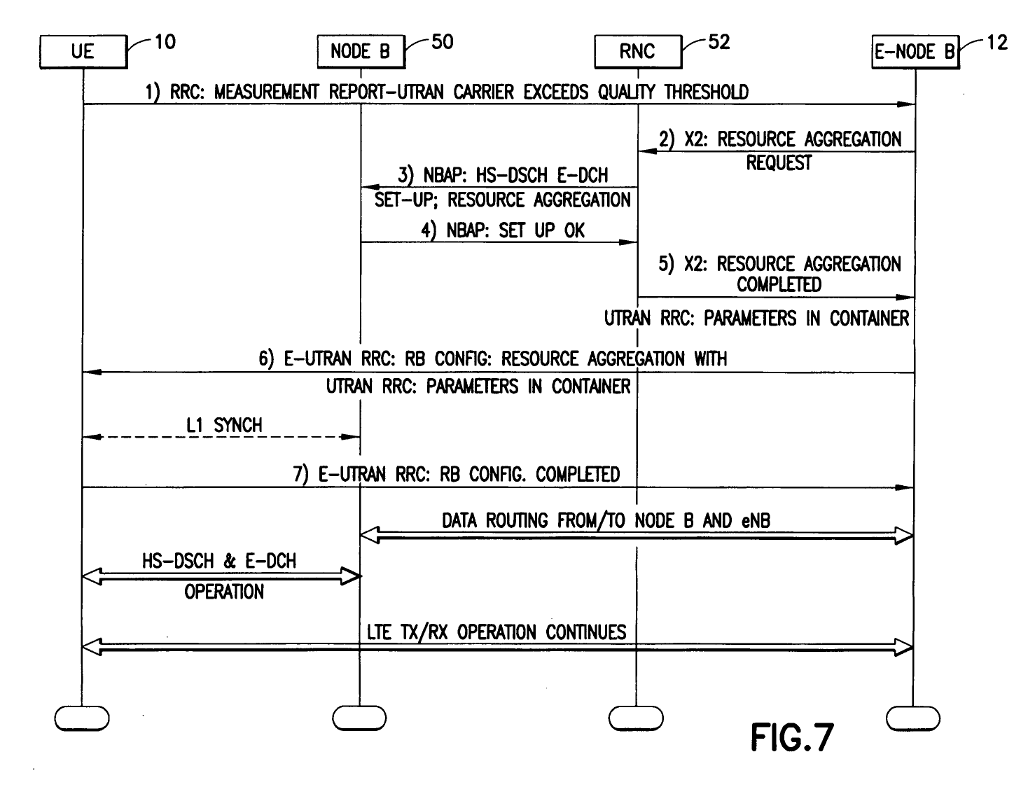

FIG. 5 shows one exemplary embodiment of the protocol stacks for the DL case of the C-Plane, with the RRC connection located at the E-UTRAN eNB 12 (designated as Point A). The discussion of the MAC-ehs made in relation to FIG. 4 is applicable as well to FIG. 5.

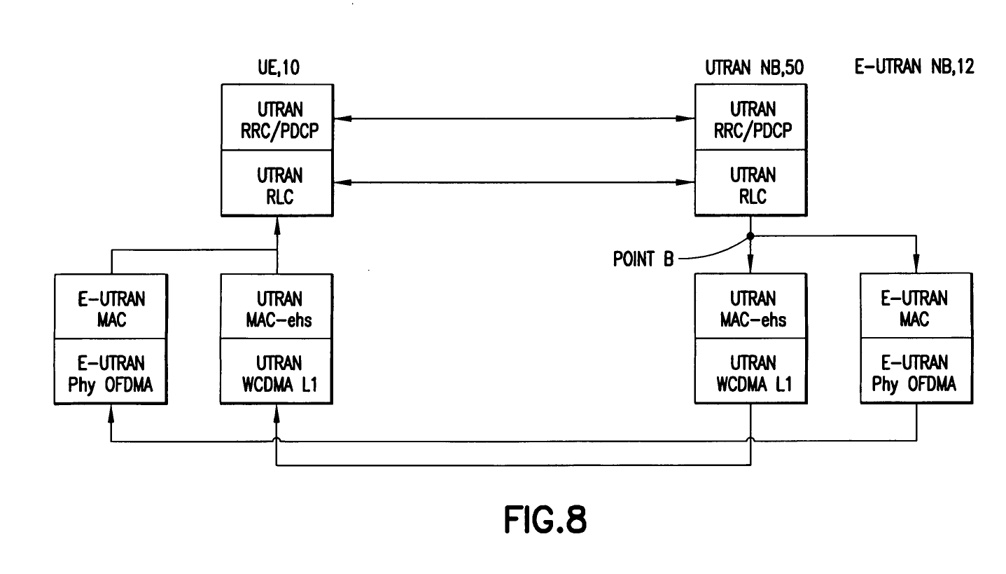

FIG. 6 shows one exemplary embodiment of the protocol stacks for the UL case (UL resource aggregation) of the U-Plane, with the RRC connection located at the E-UTRAN eNB 12 (designated again as Point A). The combination of the MAC-i (Node B 50) and MAC-is (RNC 52) can “hide” from the E-UTRAN RLC layer the UL soft HO (indicated by dashed lines) that is supported in HSUPA.

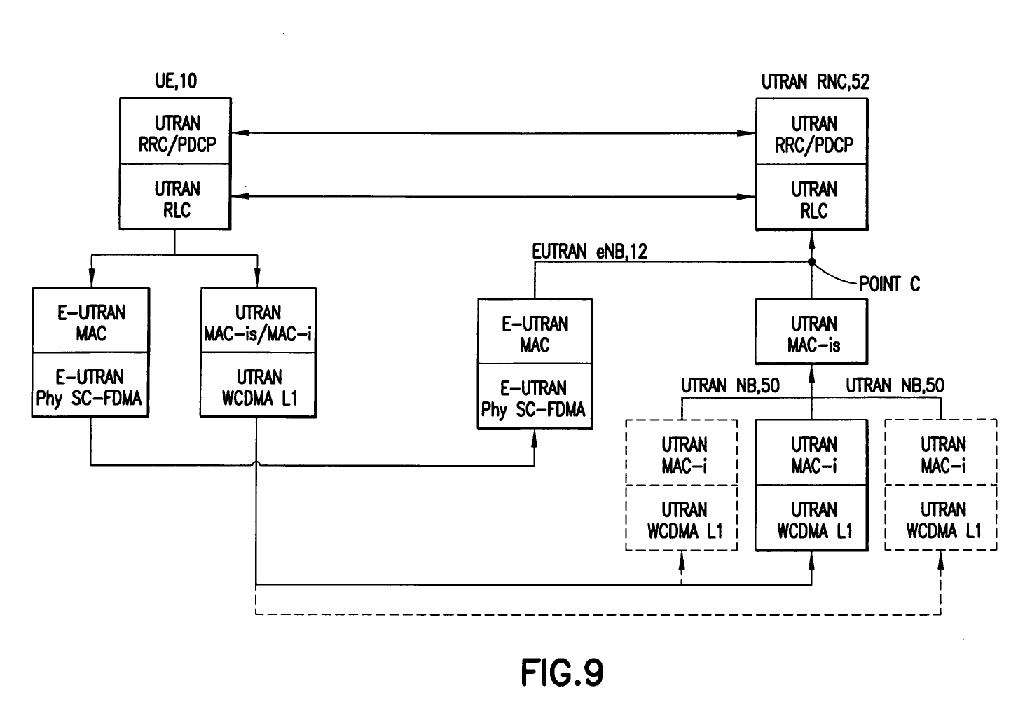

FIG. 7 illustrates an embodiment of signaling flow to initiate resource aggregation, assuming use of the RRC in E-UTRAN, in accordance with the embodiments depicted in FIGS. 4, 5 and 6.

Message 1: The UE 10 sends (the RRC layer sends) to the eNB 12 a measurement report that a detected UTRAN carrier exceeds some quality threshold suitable for reception or carrier aggregation. (utilization of the MAC layer could be anticipated).

Message 2: The eNB 12 makes a decision to initiate carrier aggregation between E-UTRAN and UTRAN and sends over the X2 or Iur or compatible interface a resource aggregation request to the UTRAN RNC. If a suitable interface does not exist the messaging via the CN 54 can be as in handover signaling between E-UTRAN and UTRAN (e.g., see 3GPP TS 36.300).

Message 3: Using NBAP signaling (see 3GPP TS 25.433) HS-DSCH and E-DCH setup with resource aggregation is performed between the RNC 52 and the Node B 50 (the Node B 50 from which the UE 10 detected the UTRAN carrier reported in Message 1).

Message 4: The Node B indicates that the setup is performed.

Message 5: Using X2 or Iur or some other compatible interface signaling the RNC 52 informs the eNB 12 that the resource aggregation is completed, and UTRAN RRC parameters are provided. If an interface does not exist the messaging via the CN 54 can be as in handover signaling between E-UTRAN and UTRAN (e.g., see 3GPP 36.300).

Message 6: The UE 10 is informed from the E-UTRAN RRC of the Radio Bearer (RB) reconfiguration regarding resource aggregation (with the UTRAN RRC parameters being provided to the UE 10). This is followed by L1 synchronization between the UE 10 and the UTRAN Node B 50.

Message 7: The UE 10 (RRC) informs the eNB 12 that RB reconfiguration is complete.

Having performed the radio bearer reconfiguration, UE-related data routing is performed between the eNB 12 and the Node B 50 (via the RNC 52 or directly between the eNB 12 and the Node B 50), HS-DSCH and E-DCH signaling takes place between the UE 10 and the Node B 50 to enable HSPA transmission operation together with E-UTRAN transmission reception. During this reconfiguration procedure the user plane (U-Plane) data transmission may be constantly ongoing between the UE 10 and the eNB 12 by using E-UTRAN TX/RX operation. After the reconfiguration procedure is completed the data is then transmitted between the UE 10 and the network via both UTRAN and E-UTRAN based on scheduling decisions made by the Node B 50 and the eNB 12. Further, if both Node B and eNB are implemented in a single physical base station device (i.e., the Node B 50 and eNB 12 are co-located) the utilization of single scheduler scheduling data transmission from both radio access technologies can be accomplished.

It can be noted with respect to FIG. 7 that Messages 2 and 5 may be routed via the UTRAN CN 54 if no interface exists between the E-UTRAN eNB 12 and the UTRAN RNC 52. The interface for this purpose may be the X2 or an Iur type (the logical connection that exists between any two RNCs within the UTRAN is referred to as the Iur interface).

It can be further noted with respect to FIG. 7 that Messages 5 and 6 may have a container to include any necessary other system parameters, or the LTE RRC may be extended to cover the necessary HSPA parameters to configure the Phy and MAC layers so that other carrier aggregation can be configured

It can be also noted with respect to FIG. 7 that data routing from/to the eNB 12 and the UTRAN Node B 50 may be performed directly using, for example, IP transport and utilization of, e.g., a UTRAN frame protocol type interface. This approach would avoid data (e.g., U-Plane data) having to flow through the RNC 52. Alternatively the data could be routed via the RNC 52.

It can be further noted with respect to FIG. 7 that L1/L2 order could activate/deactivate the resource aggregation operation when configured independently in both the LTE and HSPA. The L1/L2 orders may be referred to as simple commands to start utilizing a certain configuration. In this non-limiting example case the network could first configure the UTRAN to the UE 12, but indicate that RX/TX operation is not to be started yet. Then when the data rate requirement increases, or the channel quality increases, the network could indicate that the UE 12 is to start using the configuration previously established for UTRAN but not yet initiated. This mode of operation may thus be considered to represent a fast switch off/on scheme.

In general, mobility may be handled by the RRC of either the eNB 12 or the Node B 50. Further, in the UL scheduled grants would introduce fast load sharing, while DL schedulers would introduce fast load sharing in the DL.

In addition, it should be noted that the maximum available bandwidth would be that of the LTE system plus the HSPA system (e.g., 20 MHz for the example shown in FIG. 3). Further, note that the LTE and HSPA systems can utilize different frequency bands (e.g., 900 MHz HSPA, and 800 MHz LTE).

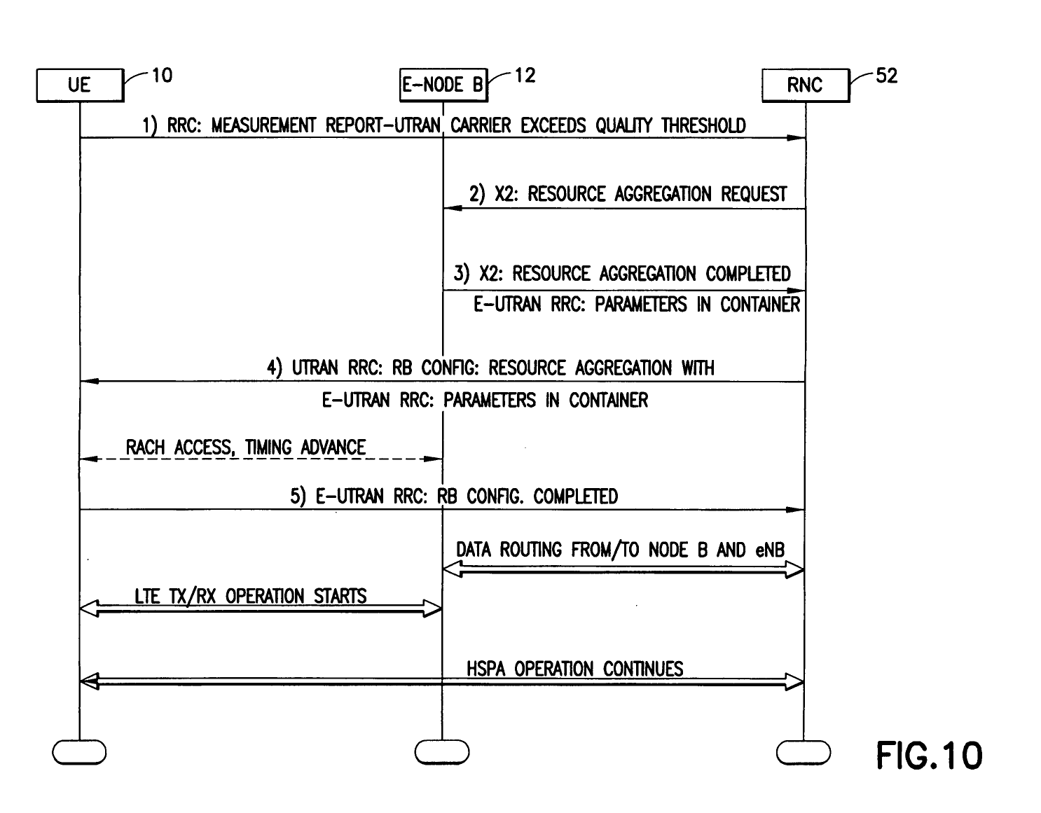

FIG. 8 shows another exemplary embodiment of protocol stacks for a DL case of the U/C-Plane, with the RRC connection located at the UTRAN Node B 50. In this case the connection (designated as Point B) is made between the RLC MAC-ehs layers of the Node B 50 and the eNB 12 MAC layer. The Point B may be a physical connection point and/or a logical connection point between the E-UTRAN eNB 12 MAC layer and the UTRAN RLC.

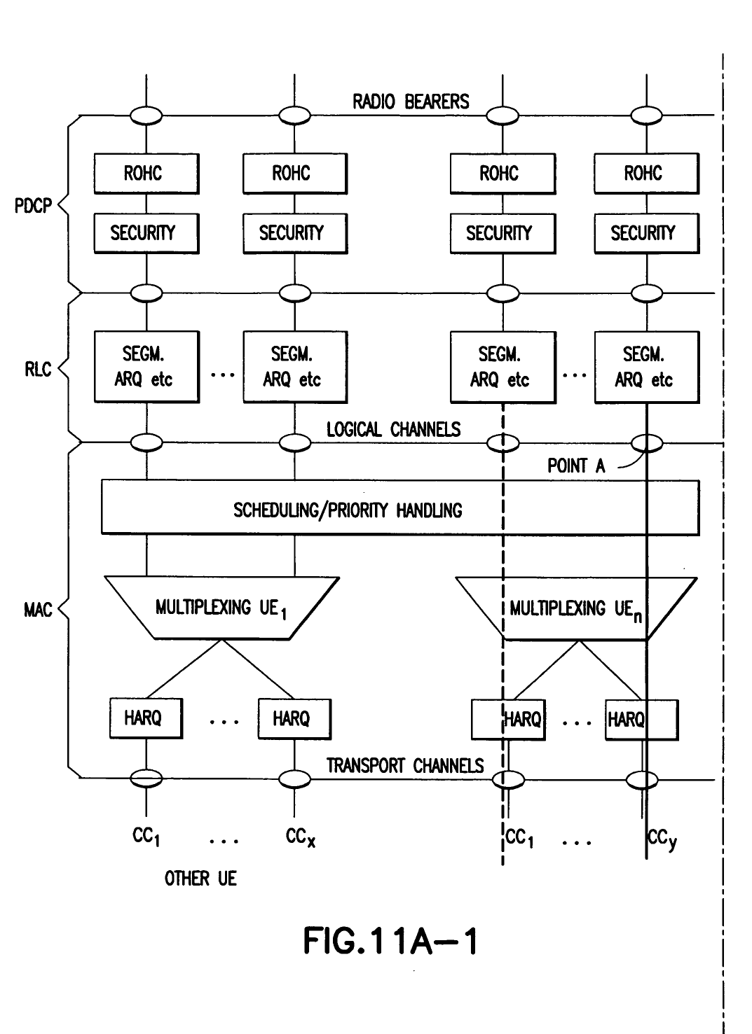

FIG. 9 shows another exemplary embodiment of protocol stacks for an UL case of the U/C-Plane, with the RRC connection located at the UTRAN RNC. In this case the connection (again designated as Point B) is made from between the RNC 52 RLC MAC-is layers and the eNB 12 MAC layer. As in FIG. 6, the dashed lines indicate the possibility for a soft HO of the UE 10 between UTRAN Node Bs 50 (via the WCDMA L1).

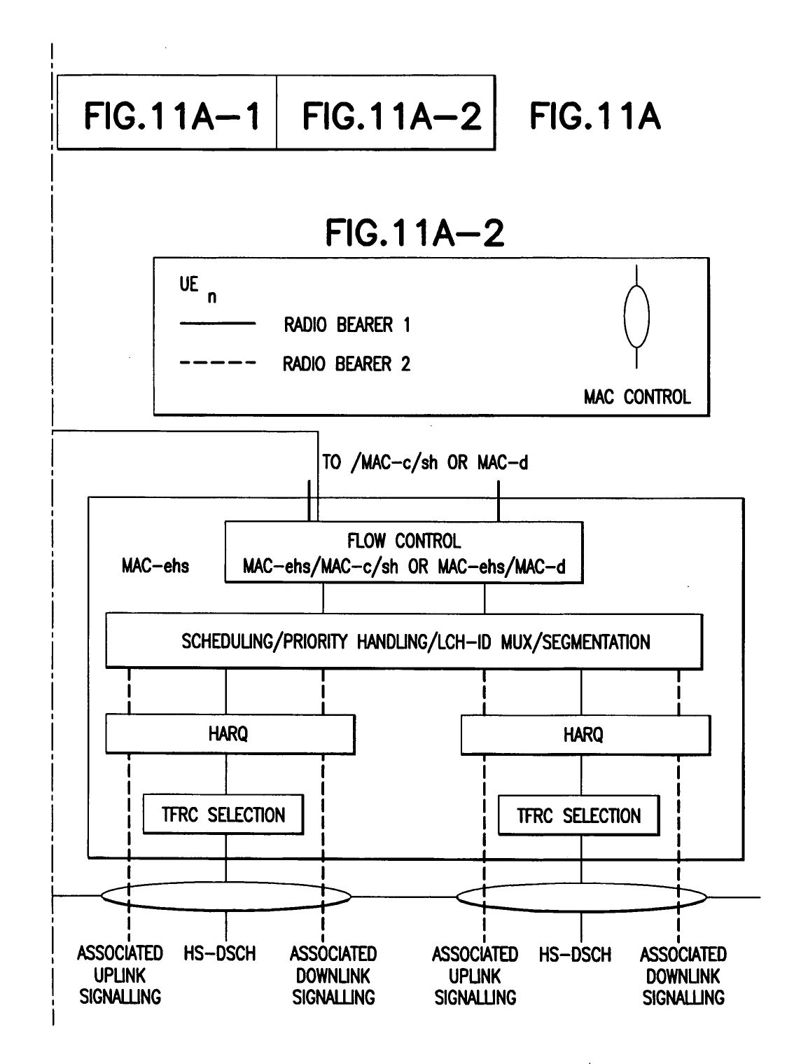

FIG. 10 illustrates an embodiment of signaling flow to initiate resource aggregation, assuming use of the RRC in UTRAN, in accordance with the embodiments depicted in FIGS. 8 and 9.

Message 1: The UE 10 sends (the RRC layer sends) to the RNC 52 (via a Node B 50) a measurement report that a detected E-UTRAN carrier exceeds some quality threshold.

Message 2: The RNC 52 sends over the X2 interface a resource aggregation request to the E-UTRAN eNB 12.

Message 3: Using the X2 interface, the eNB 12 informs the RNC 52 that resource aggregation is completed, and the E-UTRAN RRC parameters are included in a container.

Message 4: The UE 10 is informed from the UTRAN RNC 52 of the RB configuration regarding resource aggregation (with the E-UTRAN RRC parameters being provided to the UE 10). This is followed by RACH access and timing advance signaling between the eNB 12 and the UE 10.

Message 5: The UE 10 (RRC) informs the RNC 52 that RB configuration is complete.

Having established the RB, UE-related data routing is performed between the eNB 12 and the Node B 50, LTE TX/RX operation is initiated between the UE 10 and the eNB 12, and eventually HSPA TX/RX operation resumes again.

It should be noted with respect to FIG. 10 that Messages 2 and 3 could be routed via the CN 54 if no interface exists between the E-UTRAN eNB 12 and the UTRAN RNC 52. The interface for this purpose may be the X2 or an Iur type.

It can also be noted that data routing from/to the eNB 12 and the UTRAN RNC 52 can be accomplished directly via IP transport with the utilization of, for example, UTRAN frame protocol or the E-UTRAN X2 interface.

It is also noted that the particular architecture depicted in FIGS. 8, 9 and 10 may not provide a migration path from the UTRAN L2 towards the LTE layer.

In general, the embodiments depicted in FIGS. 4, 5, 6 and 7 may be considered as being preferable to the embodiments depicted in FIGS. 8, 9 and 10.

In a simplest approach the carrier aggregation is performed for both the DL and the UL so that the Phy (L1) and MAC layers can operate independently. This can imply the presence of different TX/RX frequencies, separate HARQ feedback and CQI reporting, separate scheduling requests from the UE 10 (although the RLC buffer(s) can be shared), and separate scheduling decisions by the Node B 50 and the eNB 12.

However, if only DL carrier aggregation is performed between LTE and UTRAN then it may be desirable to introduce a common control channel to indicate DL data transmission in both carriers by using a single carrier.

As should be realized, the use of the exemplary embodiments of this invention provides a number of technical advantages and technical effects. For example, there is provided a protocol and system architecture for carrier aggregation between E-UTRAN and UTRAN that is not visible to core network (S1/Iu interface), to the security or the radio access bearers. Further by example, an enhanced speed of mobility is made possible between UTRAN and E-UTRAN, in combination with an ability to support frequency dependent scheduling between E-UTRAN and UTRAN. Further, the disclosed exemplary embodiments are fully backwards compatible, allowing UTRAN Rel-99 devices and LTE Rel-8 devices to operate on E-UTRAN and UTRAN while supporting carrier aggregation. It can be noted in this regard that no changes need be made to a legacy UE 10 in order to operate with the exemplary embodiments of this invention.

Based on the foregoing it should be apparent that the exemplary embodiments of this invention provide methods, apparatus and computer programs to provide interoperability between different types of wireless communication systems operating with different types of air interfaces (e.g., OFDMA and WCDMA) to enable at least downlink radio resource aggregation for a user equipment.

The exemplary embodiments enable the provisioning of two different types of wireless networks with an ability to perform an inter-RAT HO in a novel manner.

One aspect of the exemplary embodiments of this invention is to provide, when operating with carrier aggregation, for a set of higher level (upper layer) communication functions (e.g., some or all of security (e.g., ciphering and possibly integrity protection), mobility, RRM functionality and RLC retransmission functionality (e.g., ARQ operation)) to reside at a single location in one of a plurality of wireless communication networks that have different radio access technologies. It is pointed out that in the case of the RRC being located in LTE the PDCP layer provides the integrity protection for the control signaling, while if the RRC is located in UTRAN the integrity protection is a part of the RRC functionality.

To accomplish this goal a connection between a first wireless communication system and a second wireless communication system can be made at a point between a radio link control protocol layer and a medium access control protocol layer of one of the communication systems, and a medium access control protocol layer of the other wireless communication system.

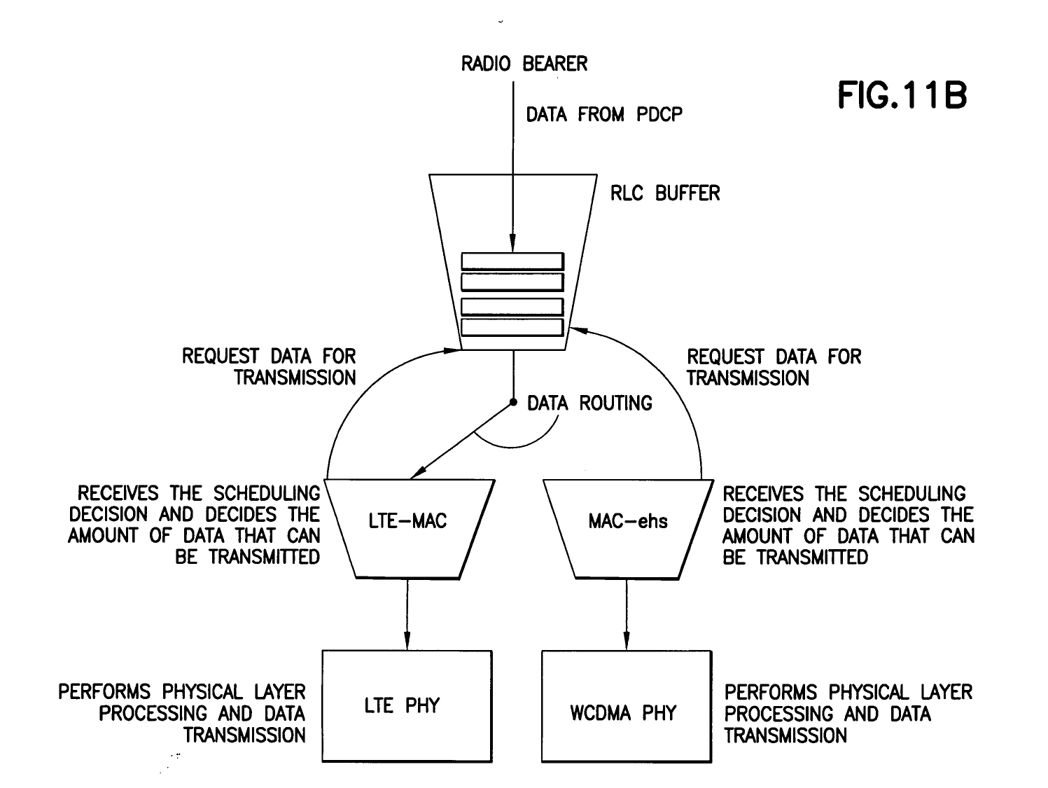

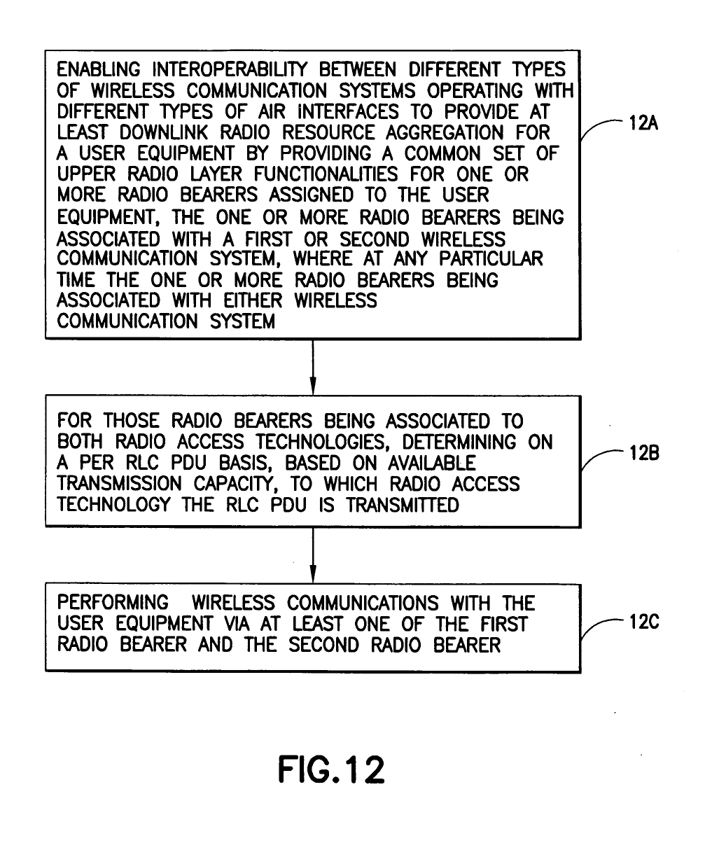

Referring to FIG. 11A there is shown a simplified diagram of a DL architecture for a case of two radio bearers (RB_1, RB_2 in this non-limiting example). Note that the upper layer function PDCP provides for at least ROHC and security (e.g., ciphering), while the RLC provides for packet segmentation, ARQ and so forth. The UEₙ is assumed in this example to be served (possibly simultaneously) by the two RBs, the RB1 in the LTE system and HSDPA system via the LTE MAC layer and MAC-ehs layer, respectively. The second radio bearer, RB2 is served in the LTE system via the LTE MAC layer alone. Note in this regard that a single radio bearer can be served by both radio access technologies, or by one, depending on the configuration. Thus, although the exemplary embodiments of this invention encompass the situation that one RB is served with LTE and other one with HSPA, in the further, possibly more interesting configuration, one RB is served with two radio access technologies while the other RB is served by another.

In accordance with an exemplary aspect of this invention the input of the MAC-ehs is connected to the LTE system at the output (for this DL case) of the LTE RLC layer, and the set of upper layer functionalities associated with the HSDPA RB is being handled by the LTE RLC and PDCP layers. In this manner, and in accordance with the exemplary embodiments of this invention, carrier aggregation of the LTE and HSPA systems is being provided to the multi-mode UEₙ.

FIG. 11B is another view of the DL architecture, one that shows the position of a data routing switch (a logical switch) between the output of RLC buffers and inputs of the LTE and UTRAN MAC layers.

Data from a single radio bearer can be configured to be transmitted via both radio access technologies as RB1, or only from one or the other radio access technologies as RB2 at any particular moment in time. The MAC-ehs and LTE MAC, when configured, request the data from the RLC layer (from the RLC buffers) based on a downlink scheduling decision done by the packet scheduler located in the BTS. As such, the RLC feeds both MAC layers by providing RLC PDUs for transmission. In the uplink direction the MAC-i/is used for E-DCH transmission in HSPA and the LTE MAC is used for PUSCH transmissions. Both MAC layers are located in the UE 10, and are requesting the data from the RLC layer based on uplink scheduling grant decisions received from the BTS. These uplink scheduling grant decisions define the maximum amount of data the UE 10 can transmit on given radio access technology at that particular moment in time. Additionally, a single RLC layer is used for both radio access technologies if RLC retransmission is needed for a RLC PDU. The PDU can be transmitted via the other access technology that it was originally transmitted on For example, assume a RLC PDU from RB2 is first transmitted via HSDPA but is not successfully received therefore requiring RLC retransmission. In this case the PDU can be re-transmitted by using the LTE radio interface technology, if a scheduling decision has provided the first possibility to re-transmit the missing PDU using the LTE radio interface technology.

In accordance with an aspect of the exemplary embodiments of this invention a single radio bearer can be transferred via both radio access technologies simultaneously, and the RLC protocol layer can be feeding both MAC layers based on their capability to transfer data. For example, the data routing decision (see again FIG. 11B) can be made on a RLC PDU by PDU basis, with the LTE system transmitting 60% of all PDUs and the WCDMA system transmitting 40% of all PDUs. However, at any particular instant in time to which radio access technology a particular PDU is being routed (i.e., the position of the logical data routing switch shown in FIG. 11B) depends on the current scheduling decision.

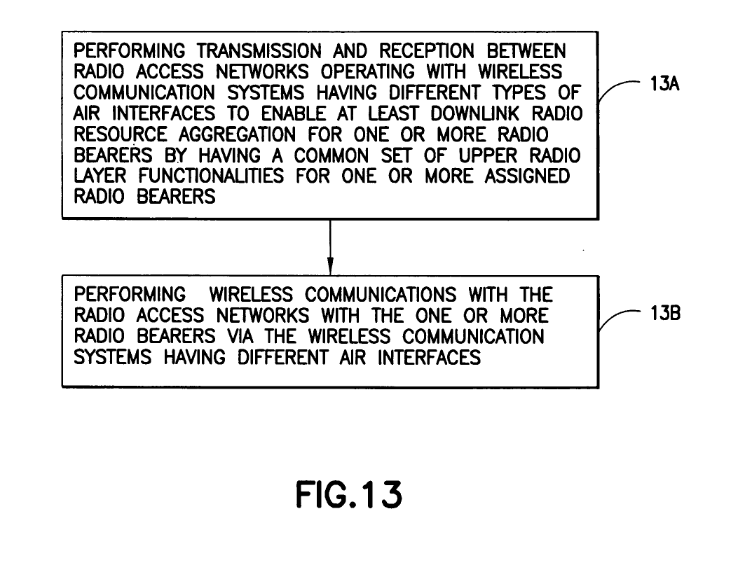

FIG. 12 is a logic flow diagram that illustrates the operation of a method, and a result of execution of computer program instructions, in accordance with the exemplary embodiments of this invention. In accordance with these exemplary embodiments a method performs, at Block 12A, enabling interoperability between different types of wireless communication systems operating with different types of air interfaces to provide at least downlink radio resource aggregation for a user equipment by providing a common set of upper radio layer functionalities for one or more radio bearers assigned to the user equipment, the one or more radio bearers being associated with a first and second wireless communication system, where at any particular time the one or more radio bearers being associated with either wireless communication system. At Block 12B there is a step, for those radio bearers being associated to both radio access technologies, of determining on a per RLC PDU basis, based on available transmission capacity (scheduling decision), to which radio access technology the RLC PDU is transmitted. At Block 12C there is a step of performing wireless communications with the user equipment via at least one of the first radio bearer and the second radio bearer.

FIG. 13 is a logic flow diagram that illustrates the operation of a method, and a result of execution of computer program instructions, further in accordance with the exemplary embodiments of this invention. In accordance with these exemplary embodiments a method performs, at Block 13A, performing transmission and reception between radio access networks operating with wireless communication systems having different types of air interfaces to enable at least downlink radio resource aggregation for one or more radio bearers by having a common set of upper radio layer functionalities for one or more assigned radio bearers. At Block 13B there is a step of performing wireless communications with the radio access networks with the one or more radio bearers via the wireless communication systems having different air interfaces.

The various blocks shown in FIGS. 12 and 13 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system and the UTRAN (HSPA) system, it should be appreciated that the exemplary embodiments of this invention are not limited for use with only these two particular types of wireless communication systems, and that they maybe used to advantage in other wireless communication systems (LTE-A and GSM).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names assigned to different protocol layers (e.g., RLC, MAC) and network elements (e.g., Node B, eNB, RLC) are not intended to be limiting in any respect, as these various protocol layers and network elements may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
enabling interoperability between different types of wireless communication systems operating with different types of air interfaces to provide at least downlink radio resource aggregation for a user equipment by
providing a common set of upper radio layer functionalities for one or more radio bearers assigned to the user equipment, the one or more radio bearers being associated with a first wireless communication system and a second wireless communication system, and
performing wireless communications with the user equipment via one or more of the radio bearers via the first and second wireless communication systems.

2. The method of claim 1, where providing comprises establishing a connection between the first wireless communication system and the second wireless communication system at a point between a radio link control protocol layer and a medium access control protocol layer of one of the wireless communication systems and a medium access control protocol layer of the other wireless communication system.

3. The method of claim 2, where the connection is made in response to a handover of the user equipment from the first wireless communication system to the second wireless communication system.

4. The method of claim 2, where the connection is a logical connection.

5. The method of claim 4, where the logical connection is made through the internet.

6. The method of claim 2, where the connection is a physical connection made through an interface defined by a specification.

7. The method of claim 6, where the interface is one of an X2 interface or an Iur interface.

8. The method of claim 1, where the set of upper radio layer functionalities comprise functions performed by a packet data convergence protocol layer and a radio link control layer, and where the set of upper radio layer functionalities comprise at least one of header compression, security, segmentation and automatic repeat request functionalities.

9. The method of claim 2, where protocol data units are switchably routed from an output of the radio link control protocol layer to an input of either one of the medium access control protocol layers on a protocol data unit by protocol data unit basis in accordance with scheduling decisions.

10. The method of claim 1, where one of the wireless communication systems is a long term evolution system operating with an orthogonal frequency division multiple access air interface, and where the other one of the wireless communication systems is a universal terrestrial radio access network system operating with a wideband code division multiple access air interface.

11. The method of claim 1, where performing wireless communications with the user equipment comprises simultaneously transmitting data to the user terminal via the first radio bearer and the second radio bearer in a first radio frequency band and in a second radio frequency band, respectively.

12. The method of claim 1, where performing wireless communications with the user equipment comprises transmitting the first radio bearer from a first base station apparatus and transmitting the second radio bearer from a second base station apparatus.

13. The method of claim 12, where the first base station apparatus and the second base station apparatus are co-located.

14. The method of claim 1, where performing wireless communications with the user equipment further comprises receiving uplink transmissions from the user equipment via at least one of a third radio bearer and a fourth radio bearer, the third radio bearer being associated with the first wireless communication system the fourth radio bearer being associated with the second wireless communication system, and processing the received uplink transmission or transmissions using the common set of upper layer functionalities.

15. An apparatus, comprising:
a processor; and
a memory including computer program code, where the memory and computer program code are configured to, with the processor, cause the apparatus at least to perform enabling interoperability between different types of wireless communication systems operating with different types of air interfaces to provide at least downlink radio resource aggregation for a user equipment by providing a common set of upper radio layer functionalities for one or more radio bearers assigned to the user equipment, the one or more radio bearers being associated with different types of wireless communication systems; and performing wireless communications with the user equipment with one or more radio bearers via the different types of wireless communication systems.

16. The apparatus of claim 15, where providing comprises establishing a connection between the different types of wireless communication systems at a point between a radio link control protocol layer and a medium access control protocol layer of one of the communication systems and a medium access control protocol layer of the other wireless communication system.

17. The apparatus of claim 16, where the connection is made in response to a handover of the user equipment from the first wireless communication system to the second wireless communication system.

18. The apparatus of claim 16, where the connection is at least one of a logical connection and a physical connection made through an interface defined by a specification.

19. The apparatus of claim 18, where the logical connection is made through the internet, and where the interface is one of an X2 interface or an Iur interface.

20. The apparatus of claim 15, where the set of upper radio layer functionalities comprise functions performed by a packet data convergence protocol layer and a radio link control layer, and comprise at least one of header compression, security, segmentation and automatic repeat request functionalities.

21. The apparatus of claim 15, where one of the wireless communication systems is a long term evolution system operating with an orthogonal frequency division multiple access air interface, and where the other one of the wireless communication systems is a universal terrestrial radio access network system operating with a wideband code division multiple access air interface.

22. The apparatus of claim 15, where performing wireless communications with the user equipment comprises simultaneously transmitting data to the user terminal via the first radio bearer and the second radio bearer in a first radio frequency band and in a second radio frequency band, respectively.

23. The apparatus of claim 15, where performing wireless communications with the user equipment comprises transmitting the first radio bearer from a first base station apparatus and transmitting the second radio bearer from a second base station apparatus.

24. The apparatus of claim 23, where the first base station apparatus and the second base station apparatus are co-located.

25. The apparatus of claim 15, where performing wireless communications with the user equipment further comprises receiving uplink transmissions from the user equipment via at least one of a third radio bearer and a fourth radio bearer, the third radio bearer being associated with the first wireless communication system the fourth radio bearer being associated with the second wireless communication system, and processing the received uplink transmission or transmissions using the common set of upper layer functionalities.

26. The apparatus of claim 15, where protocol data units are switchably routed from an output of the radio link control protocol layer to an input of either one of the medium access control protocol layers on a protocol data unit by protocol data unit basis in accordance with scheduling decisions

27. A method comprising:
performing transmission and reception between radio access networks operating with wireless communication systems having different types of air interfaces to enable at least downlink radio resource aggregation for one or more radio bearers by having a common set of upper radio layer functionalities for one or more assigned radio bearers; and
performing wireless communications with the radio access networks with the one or more radio bearers via the wireless communication systems having different air interfaces.

28. The method of claim 27, executed in a multi-mode user equipment.

29. An apparatus, comprising:
a processor; and
a memory including computer program code, where the memory and computer program code are configured to, with the processor, cause the apparatus at least to perform transmitting and receiving with radio access networks operating with wireless communication systems having different types of air interfaces to enable at least downlink radio resource aggregation for one or more radio bearers by having a common set of upper radio layer functionalities for one or more assigned radio bearers; and
performing wireless communications with the radio access networks with the one or more radio bearers via the wireless communication systems having different air interfaces.

30. The apparatus of claim 29, embodied in a multi-mode user equipment.
